(19) United States
(12) Patent Application Publication
(10) Pub. No.: US 2026/0178685 A1
(43) Pub. Date: Jun. 25, 2026

(54) FAULT TOLERANT ITERATIVE SOLVER FOR ALGEBRAIC LINEAR SYSTEMS IN CONTROLLER-WORKER COMPUTING SYSTEMS

(71) Applicant: International Business Machines Corporation, Armonk, NY (US)

(72) Inventors: Vasileios Kalantzis, Nyack, NY (US); Lior Horesh, North Salem, NY (US)

(21) Appl. No.: 18/987,129

(22) Filed: Dec. 19, 2024

(51) Int. Cl. G06F 17/12; G06F 17/16

(52) U.S. Cl. CPC G06F 17/12; G06F 17/16

(57) ABSTRACT

Mechanisms are provided for fault-tolerant computing. The mechanisms solve, by a controller computing device in a controller-worker computer architecture, a sparse algebraic linear system of equations with incomplete matrix-vector products. The solving includes: A set of worker computing devices computing matrix-vector products Ax=b, wherein A is a sparse matrix, x is a vector being multiplied, and b is a resultant vector; a controller determining that a worker has not returned a result of its computation within a threshold length of time; and in response to the determination, assuming, by the controller computing device, that the result of the worker computing device computation is zero and continuing the computing of a solution to the sparse algebraic linear system. The controller computing device provides, to a subsequent computing operation, the solution to the sparse algebraic linear system of equations as a basis for performing the subsequent computing operation.

### BACKGROUND

The present application relates generally to a data processing apparatus and method and more specifically to a computing tool and computing tool operations and functionality for solving algebraic linear systems in an iterative fault tolerant manner with regard to controller-worker computing systems.

Reliable computing has become a key challenge when deploying applications on large-scale computer platforms. Fault tolerance is the property that enables a computer platform to continue operating properly in the event of the failure of one or more of its components, i.e., one or more faults. These computer platforms are confronted with frequent errors occurring due to extremely large numbers of floating point operations executed by parallel applications that are deployed on these computer platforms. The probability of facing a corrupted floating point operation is proportional to the number of such operations that are executed. Even if each processor exhibits a low individual error rate, the probability of several errors occurring during the execution of parallel applications becomes very high with millions of cores running in parallel for hours or even days. As computing environments become larger over time, require more power, and utilize a more hybrid architecture, e.g., co-existence of Central Processing Units (CPU), Graphics Processing Unites (GPUs), and Tensor Processing Units (TPUs), analog hardware, quantum computers, etc., soft and/or hard failures are destined to take place more often.

A fault-tolerant design of a computing system enables a system to continue its intended operation, possibly at a reduced level, rather than failing completely when some part of the system fails. Once approach to detecting computation errors consists of replicating computations and checking that both executes produce a same result. If they do not coincide, an error has been detected and the application must be executed a third time. Other application specific approaches can also be used, such as Algorithm-Based Fault Tolerance (ABFT) and Residual Checking (RC). Regardless, however, identifying and correcting errors is a very computational and resource expensive endeavor.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method of fault-tolerant computing is provided. The method comprises solving, by a controller computing device in a controller-worker computer architecture, a sparse algebraic linear system of equations with incomplete matrix-vector products. The solving comprises: (1) computing, by a set of worker computing devices in the controller-worker computer architecture, matrix-vector products Ax=b, wherein A is a sparse matrix, x is a vector being multiplied, and b is a resultant vector; (2) determining, by the controller computing device, that a worker has not returned a result of its computation to the controller computing device within a threshold length of time; and (3) in response to determining that a worker has not returned its result within the threshold length of time, assuming, by the controller computing device, that the result of the worker computing device computation is zero and continuing the computing of a solution to the sparse algebraic linear system. The method further comprises providing, by the controller computing device, to a subsequent computing operation, the solution to the sparse algebraic linear system of equations as a basis for performing the subsequent computing operation.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram illustrating a client-server (controller-worker) computer architecture in accordance with one illustrative embodiment;

FIG. 2 is an example diagram of a distributed data processing system environment in which aspects of the illustrative embodiments may be implemented and at least some of the computer code involved in performing the inventive methods may be executed;

FIG. 3 is an example block diagram of a fault tolerant linear solver for a controller computing system in a controller-worker computer architecture in accordance with one illustrative embodiment;

FIG. 4A is an example diagram of an algorithm for a pre-conditioner implementing a stationary linear solver in accordance with one illustrative embodiment;

FIG. 4B is an example diagram of an algorithm for a fault tolerant non-stationary linear solver with a preconditioning based on a stationary linear solver in accordance with one illustrative embodiment; and

FIG. 5 is a flowchart outlining an example operation of a fault tolerant non-stationary linear solver in accordance with one illustrative embodiment.

### DETAILED DESCRIPTION

The illustrative embodiments provide a computing tool and computing tool operations and functionality for solving algebraic linear systems in a fault tolerant manner with regard to controller-worker computing systems. The illustrative embodiments address problems in controller-worker computing systems with regard to non-dedicated resources and load imbalances which may lead to workers not providing results in sufficient time to avoid significant performance bottlenecks in the solving of such algebraic linear systems. The illustrative embodiments provide computing tool mechanisms to perform the solving of the algebraic linear systems as sparse matrix-vector-multiplication (MVM) problems which increases the speed of the solving of the algebraic linear systems when faults or significant performance bottlenecks may otherwise be present.

Algebraic linear systems are present in many different types of computing operations. For example, in electrical circuit design, algebraic linear systems are involved in the evaluation of resistance networks using systems of equations of the type V=IR (Ohm's law), where I is the current, V is the voltage, and R is the resistance. In social networking applications, algebraic linear systems are involved in the evaluation of “friends” networks which identify linkages between users of the social network. In web page search engines, web pages may be evaluated based on their linkages with other webpages, e.g., using a page rank type mechanism, where algebraic linear systems are used to perform such evaluations. The solving of algebraic linear systems is an important aspect of a large and widely varying set of computer operations, not all of which can be discussed herein. Thus, improving the way that such algebraic linear systems are solved by computing systems, especially in the event of runtime faults, provides an improvement to any computing system and/or algorithms that operate based on such algebraic linear systems.

In one or more illustrative embodiments, the computing tool and computing tool operations work in conjunction with a controller-worker computing system architecture in which one computing device, processor, or the like, operates as a controller and other computing devices, processors (physical and/or virtual), or the like, operate as workers to perform operations on vectors for solving an algebraic linear system. The illustrative embodiments recognize that in such a controller-worker computing system, various sources of error may be present which cause a worker to not return results to the controller, e.g., the worker may timeout and not return results withing a given period of time, the worker may fail, or a plethora of other potential runtime faults. The illustrative embodiments provide computer operations and a computing tool that addresses such situations where results from one or more of these workers are unavailable and unable to be used in solving the algebraic linear system.

The following description provides examples of embodiments of the present disclosure, and variations and substitutions may be made in other embodiments. Several examples will now be provided to further clarify various aspects of the present disclosure.

Example 1: A method of fault-tolerant computing is provided. The method comprises solving, by a controller computing device in a controller-worker computer architecture, a sparse algebraic linear system of equations with incomplete matrix-vector products. The solving comprises: (1) computing, by a set of worker computing devices in the controller-worker computer architecture, matrix-vector products Ax=b, wherein A is a sparse matrix, x is a vector being multiplied, and b is a resultant vector; (2) determining, by the controller computing device, that a worker has not returned a result of its computation to the controller computing device within a threshold length of time; and (3) in response to determining that a worker has not returned its result within the threshold length of time, assuming, by the controller computing device, that the result of the worker computing device computation is zero and continuing the computing of a solution to the sparse algebraic linear system. The method further comprises providing, by the controller computing device, to a subsequent computing operation, the solution to the sparse algebraic linear system of equations as a basis for performing the subsequent computing operation.

The above limitations advantageously enable the determination of a solution for a sparse algebraic linear system of equations even in cases where not all of the matrix-vector products are observable. The illustrative embodiments avoid bottlenecks in the computing of solutions to sparse algebraic linear systems by providing a mechanism to assume matrix-vector product results when the actual matrix-vector products are not observed within a predetermined threshold period of time. This increases the speed by which such solutions to sparse algebraic linear systems may be generated in computing systems and improves subsequent downstream operations that utilize the solution to the sparse algebraic linear system as a basis.

Example 2: The limitations of any of Examples 1 and 3-10, where the solving uses a flexible iterative solver preconditioned by a Richardson Iteration preconditioner with inexact matrix-vector products. The above limitations advantageously enable the use of inexact results in determining the solution of the algebraic linear system which can be computed even in the case of faults occurring with regard to one or more worker computing devices.

Example 3: The limitations of any of Examples 1-2 and 4-10, where the flexible iterative solver is a flexible generalized minimal residual method algorithm, and wherein the Richardson Iteration preconditioner is a random Richardson Iteration algorithm comprising a random variable T representing a number of worker computing devices that successfully provide their corresponding matrix-vector product computation results to the controller computing device. The above limitations advantageously enable the use of inexact results in determining the solution of the algebraic linear system in which the inexact results may be modeled using randomized determinations of the number of successfully operating worker computing devices.

Example 4: The limitations of any of Examples 1-3 and 5-10, where computing the matrix-vector products comprises distributing, by the controller computing device to each worker computing device in the set of worker computing devices, the resultant vector b and a portion of the sparse matrix A. The above limitations advantageously enable the matrix-vector multiplication operations to be distributed across a plurality of worker computing devices for parallel execution of the computations of portions of the matrix-vector multiplication which can then be aggregated by the controller computing device. This increases the speed by which the solution to the sparse algebraic linear system is computed.

Example 5: The limitations of any of Examples 1-4 and 6-10, where the portion of the sparse matrix A provided to a worker computing device in the set of worker computing devices, is a corresponding row of the matrix A. The above limitations advantageously enable each worker computing device to generate a portion of the solution to the sparse algebraic linear system corresponding to a row of the matrix A and the vector b.

Example 6: The limitations of any of Examples 1-5 and 7-10, where computing the matrix-vector products further comprises computing, by each of one or more first worker computing devices in the set of worker computing devices, a corresponding matrix-vector product for the algebraic linear system of equations, to thereby determine an element in x. The above limitations advantageously enable a first subset of the worker computing devices to provide actual elements of the solution x through successful completion of their computations of the matrix-vector multiplication.

Example 7: The limitations of any of Examples 1-6 and 8-10, wherein the set of worker computing devices further comprise one or more second worker computing devices that do not return a corresponding result to the controller computing device within the threshold length of time, and wherein the elements in x corresponding to the one or more second worker computing devices are set to a value of 0. The above limitations advantageously enable a first subset of the worker computing devices to provide actual elements of the solution x through successful completion of their computations of the matrix-vector multiplication, and a second subset of worker computing devices having their elements of the solution x being set to 0 when this second subset does not provide their results within the threshold period of time.

Example 8: The limitations of any of Examples 1-7 and 9-10, WHERE the one or more second worker computing devices are worker computing devices that have encountered a runtime fault or failure. The above limitations advantageously enable the efficient computation of the solution to a sparse algebraic linear system of equations even in the presence of faulty worker computing devices, regardless of the reason for the fault. This speeds up computation of the solution to the sparse algebraic linear system of equations in that the controller computing device does not need to wait for a response from worker computing devices who have not provided their results within the predetermined threshold period of time.

Example 9: The limitations of any of Examples 1-8 and 10, where the set of worker computing devices are part of a cloud computing system in which one or more of the worker computing devices in the set of worker computing devices are not dedicated only to computing matrix-vector products for solving the linear system of equations and instead perform other operations in addition to computing matrix-vector products for solving the linear system of equations. The above limitations advantageously enable the efficient and faster computation of solutions to sparse algebraic linear systems of equations in computing systems in which computing devices performing the matrix-vector multiplication computations are not dedicated machines, such as in cloud computing systems.

Example 10: The limitations of any of Examples 1-9, where the subsequent computing operation is one of an electrical circuit design operation, a social networking application operation, or a web page search engine operation. The above limitations advantageously enable the increasing of the speed of computations of solutions to sparse algebraic linear systems of equations, which are often present in electrical circuit design operations, social networking application operations, and web page search engine operations.

Example 11: A system comprising one or more processors and one or more computer-readable storage media collectively storing program instructions which, when executed by the one or more processors, are configured to cause the one or more processors to perform a method according to any one of Examples 1-10. The above limitations advantageously enable a system comprising one or more processors to perform and realize the advantages described with respect to Examples 1-10.

Example 12: A computer program product comprising one or more computer readable storage media, and program instructions collectively stored on the one or more computer readable storage media, the program instructions comprising instructions configured to cause one or more processors to perform a method according to any one of Examples 1-10. The above limitations advantageously enable a computer program product having program instructions configured to cause one or more processors to perform and realize the advantages described with respect to Examples 1-10.

The mechanisms of the illustrative embodiments provide a computing tool that computes the solution of sparse linear systems when matrix-vector-multiplication (MVM), with the coefficient matrix, is only partially observed due to runtime faults, where “observability” refers to a measure of how well internal states of a system can be inferred from knowledge of its external outputs. That is, if one is computing the MVM of a matrix A and a vector x, with the result being designated b (i.e., Ax=b), one cannot observe b but instead observes entries in b, and one can only observe some of these entries in b, e.g., if b has 10 entries, one may only be able to observe 3 or 5 entries of b. For example, such situations occur when worker devices are not able to return results from the processing of the workloads that they are given. That is, if a worker cannot return its results within a given time period, those results are not observed by the controller when attempting to solve the algebraic linear system and hence, the linear system is considered sparse and the MVM is only partially observed.

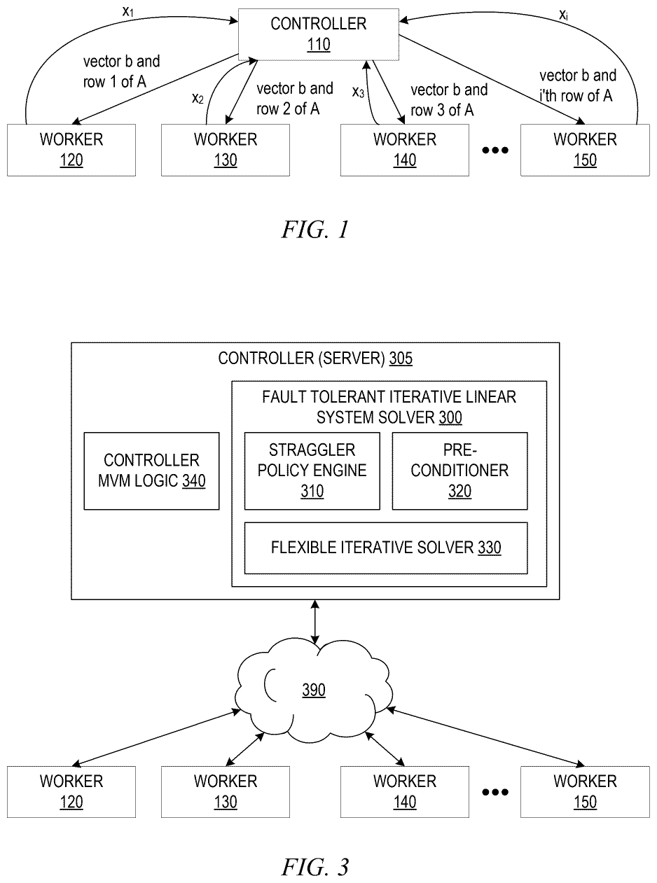

To further illustrate the problem in computing systems addressed, consider a client-server model in accordance with one illustrative embodiment, such as that shown in FIG. 1, where a server operates as a controller 110 and the client computing devices are the workers 120-150 for the controller 110. With an algebraic linear system in which a system of linear equations of the type Ax=b is to be solved the controller (server) 110 may send a portion of the matrix A and the vector b to all the N workers (clients) 120-150 and receive a scalar result from them, i.e., the i^{th} entry of x. A is a matrix, e.g., an N×N matrix, b is a vector, and x is the unknown vector that satisfies the linear system, where b is the vector result of the matrix-vector product Ax. In some illustrative embodiments, each worker 120-150 receives one of the rows of the matrix A along with the vector b, i.e., the i^{th} worker receives the i^{th} row of the matrix A. Each worker performs computations of the scalar product between the vector x and the i^{th} row of A assigned to it, and returns the scalar result to the controller 110. Each worker 120-150 performs its task independently, while the controller 110 aggregates the scalars produced each of the N workers 120-150.

If the workers (clients) 120-150 are on a cloud computing system where the resources of the cloud computing system are dedicated to those workers 120-150, then each worker 120-150 will take about the same amount of time to process their workloads and will have approximately the same amount of workload. However, if the cloud computing system were a shared cloud computing system, where multiple different organizations or users are using the resources of that cloud computing system to execute different operations and workloads, the non-dedicated resources cause each worker 120-150 to potentially have differing workloads and have differing amounts of available resources to allocated to them for processing of these different workloads. That is, some workers 120-150 are more/less loaded than others, have more/less resources than others, and may be potentially faster/slower than others, such that they return results within varying amounts of time. In short, non-dedicated resources in cloud computing systems may result in load unbalancing and may lead to potential runtime faults when attempting to solve algebraic linear systems. Moreover, this unbalanced load may change over time with different workers 120-150 being more/less loaded and having more/less resources at different periods of time such that the same worker 120 may be responding appropriately within one period of time, but may take too long to generate results in the next period of time.

The workers 120-150 that fail to provide results within a predefined allotted time frame are referred to herein as “stragglers”. A “straggler” is a task or process that takes significantly longer to complete than the majority of other tasks or processes in a distributed or parallel computing environment. These stragglers may represent a significant bottleneck in computations that rely on efficient use of multiple processors, such as in the case of scientific computations and the like. These stragglers may be present due to hardware variability, resource contention, load imbalance, faulty nodes, data skew, and the like.

In general, it is not possible to determine a priori how long each worker 120-150 will need to execute until it returns its part of the matrix-vector product of Ax. This is especially the case when the workers are not dedicated to a particular application and are distributed across several geographical regions, as in cloud computing infrastructures. Thus, the likelihood of stragglers is much greater in such non-dedicated distributed or parallel computing infrastructures. Moreover, the possibility of stragglers becomes increasingly the case for larger values of N since, even when the probability that each worker slows down or becomes unresponsive is small, the chance that at least one worker becomes a straggler increases, and so does the expected latency of the iterative solver.

With the mechanisms of the illustrative embodiments, if a worker 120-150 is a straggler, i.e., does not return their result within an allotted period of time, the worker's corresponding result is assumed to be 0 and the controller 110 continues on with the solving of the algebraic linear system using a sparse linear system solver mechanism. This leads to a sparse matrix-vector product in which some entries of the sparse matrix-vector product are replaced with zeroes. This implies that the actual matrix-vector product is not computed. However, in accordance with the illustrative embodiments, subject to a general probability model, the actual solution of the sparse vector algebraic linear system can still be computed.

The illustrative embodiments provide a pre-conditioned fault tolerant algebraic linear solver computing tool, more simply referred to herein as a fault-tolerant linear solver, and corresponding operations and functionality which solves such sparse vector algebraic linear systems. The mechanisms of the illustrative embodiments may be applied as-is in any data processing system and/or any application executing on a data processing system that requires solving linear systems in a fault-tolerant manner, e.g., computer applications that operate on, or include operations that involve, solving numerical partial differential equations (PDEs), and the like. For purposes of the present description, an illustrative example operation in which a controller-worker architecture of computing devices will be used to further illustrate the operation of the present invention.

With the mechanisms of the illustrative embodiments, since the non-observed entries of the MVM operations are set equal to zero after an allotted amount of time in order to speed up the solving of the algebraic linear system, the matrix A can only be partially observed. Thus, the mechanisms of the illustrative embodiments implement a combination of pre-conditioning and iterative solver with inexact or approximated MVM solutions in order to avoid the problems accompanying the inability to perform accurate MVM with the matrix A, which will delay convergence considerably, especially after restarting. The pre-conditioning of the illustrative embodiments overcomes the challenges observed due to the randomness involved in the MVM. The pre-conditioning utilizes an algorithm that generates an approximate solution for the vector x in the linear system Ax=b. The iterative solver uses inexact matrix-vector products with the approximate solutions from the pre-conditioner to generate a solution for the algebraic linear system.

Thus, the illustrative embodiments provide an iterative scheme that aims to remedy the above challenges. More specifically, in one or more of the illustrative embodiments, a Flexible Generalized Minimal Residual Method (GMRES) algorithm is utilized, which is a variant of GMRES that incorporates variable pre-conditioning directly into the Krylov subspace. The GMRES algorithm is an iterative method for the numerical solution of an indefinite nonsymmetric system of linear equations. The method approximates the solution by the vector in a Krylov subspace with minimal residual. In linear algebra, the order-r Krylov subspace generated by an N×N matrix A and a vector b of dimension n is the linear subspace spanned by the images of b under the first r powers of A (starting from A0=I), that is:

$${𝒦}_{r} ( A , b ) = span \{ b , Ab , {A}^{2} b , … , {A}^{4 - 1} b \}$$

Krylov subspaces are used in algorithms for finding approximate solutions to high-dimensional linear algebra problems.

The proposed solution according to one or more of the illustrative embodiments extends the Krylov subspace via averaging over several partial MVM with the same right hand side of the linear equation, i.e., b in Ax=b, in order to compute a more accurate MVM with the matrix A. Moreover, in one or more of the illustrative embodiments, the pre-conditioning step is accomplished by performing a few steps of a Richardson iteration, which is an iterative method for solving a system of linear equations. If the set of linear equations is Ax=b, then the Richardson iteration is provided as:

$${x}^{( k + 1 )} = {x}^{( k )} + w ( b - A {x}^{( k )} )$$

where w is a scalar parameter that is chosen such that the sequence x^{(k)} converges. The Richardson iteration of the illustrative embodiments is a preconditioner to the Flexible GMRES iterative solver and operates as an inner iteration scheme for the Flexible GMRES iterative solver.

The Richardson iteration of the illustrative embodiments is a precondition er to the Flexible GMRES iterative solver and operates as an inner iteration scheme for the Flexible GMRES iterative solver. This means that during the execution of the Flexible GMRES algorithm, the Richardson iteration is employed to improve the convergence properties of the solver. By preconditioning the matrix, the Richardson iteration helps to transform the original problem into a form that is more amenable to rapid convergence within the GMRES framework. In practical terms, this involves applying the Richardson method within each iteration of the Flexible GMRES solver, thereby iteratively refining the solution to better approximate the true result with each step. This nested approach leverages the strengths of both methods: the simplicity and efficiency of Richardson iteration to reduce the computational burden of each GMRES iteration, and the robustness of GMRES in handling a wide range of linear system types, particularly those that are large and sparse.

Thus, by implementing a policy that the results values for stragglers are set to 0, and utilizing a preconditioned iterative solver in which the preconditioning generates an approximation of the algebraic linear system solution for the inner iterations of the iterative solver, which generates the actual solution to the algebraic linear system solution, an accurate solution is generated even in the presence of stragglers.

As mentioned above, the illustrative embodiments may be implemented with any computing system and/or computing algorithms that operate to solve algebraic linear systems. For example, in some illustrative embodiments, the computing tool may involve applications in which a geometrical structure is imported or created and preprocessed with a mesh, with possible application of physics algorithms. The mechanisms of the illustrative embodiments may be applied during the solving of engineering problems associated with the mesh with defined physics, and the results being output via a visualization tool along with analysis results.

As another example, electrical networks are specialized types of networks that provide information about power sources, such as batteries, and devices powered by these sources, e.g., light bulbs, motors, and the like. A power source forces a current to flow through the network, where it encounters various resistors, each of which requires a certain amount of force to be applied in order for the current to flow through. Circuit analysis is the process of finding all the currents and voltages in a network of connected components. This circuit analysis may involve systems of linear equations that are used to determine the currents through various branches of the electrical networks. For example, this circuit analysis may involve using Ohm's Law to determine the voltage drop across a resistor given by V=IR (voltage equals current multiplied by resistance), Kirchhoff's Law which states that the sum of the IR terms in any direction around a closed path is equal to the total voltage in the path in that direction, and others. These equations together constitute a system of linear equations. Simulations and other computer models operating on circuit designs may be required to invoke a linear solver to solve such systems of linear equations, with the mechanisms of the illustrative embodiments providing specific improvements to these computer tools providing linear solvers.

Before continuing the discussion of the various aspects of the illustrative embodiments and the computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to a computing tool and the methodology implemented by this computing tool. In particular, the computing tool of the illustrative embodiments specifically provides an iterative solver for algebraic linear systems that is fault tolerant. The computing tool implements mechanism and functionality, such as a fault tolerant linear system iterative solver, which cannot be practically performed by human beings either outside of, or with the assistance of, a technical environment, such as a mental process or the like. The computing tool provides a practical application of the methodology at least in that the computing tool is able to solve algebraic linear systems even in the presence of faults by assuming a policy of a default value for entries when workers are determined to be stragglers. In addition, the computing tool provides a practical application of the methodology that performs a preconditioned flexible iterative solving of the algebraic linear system given this policy. Such a solution for algebraic linear systems is a specific improvement to the operation of various computing systems and computing algorithms that rely on the computation of algebraic linear systems to perform their operations, such as the examples previously mentioned above.

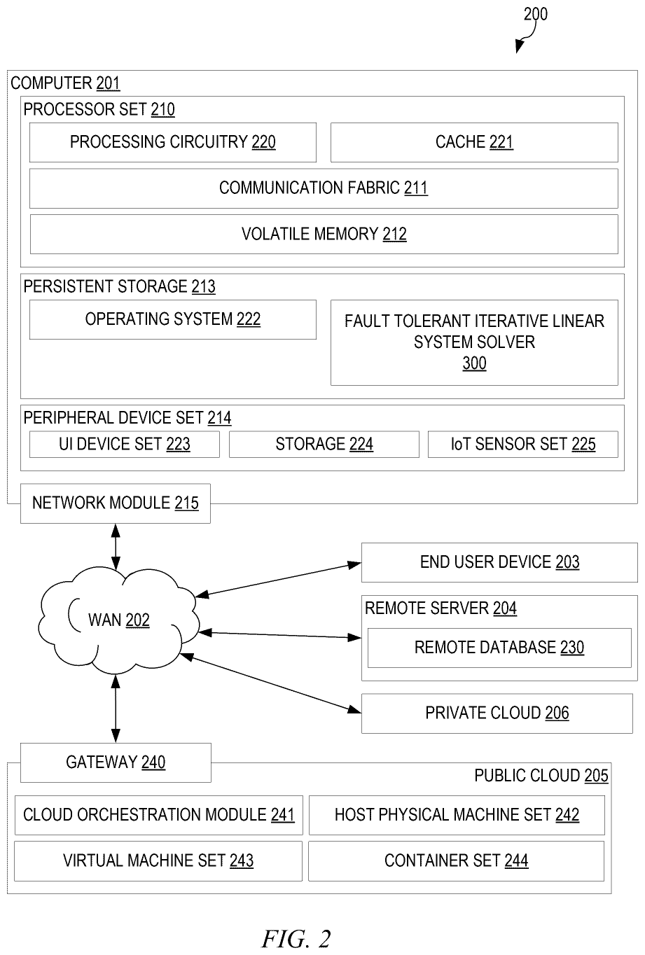

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as fault tolerant iterative linear system solver 300. In addition to fault tolerant iterative linear system solver 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and fault tolerant iterative linear system solver 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in fault tolerant iterative linear system solver 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in fault tolerant iterative linear system solver 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a fault tolerant iterative linear system solver 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates solving algebraic linear systems even in the presence of stragglers presenting faults to the computations, where the mechanisms of the illustrative embodiments specifically improve the speed by which such solutions may be generated by avoiding delays and performance issues due to such straggles, especially in controller-worker architectures and distributed computing architectures where the workers are not dedicated workers.

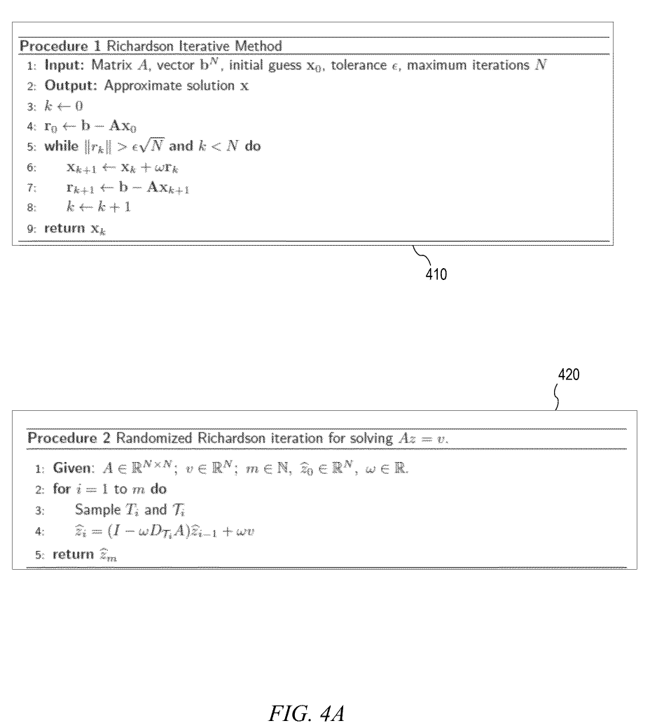

FIG. 3 is an example block diagram of a fault tolerant linear solver for a controller computing system in a controller-worker computer architecture in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that algebraic linear systems are solved in distributed computing systems, such as controller-worker architectures, especially in the presence of stragglers or faults on the part of the workers. The mechanisms of the illustrative embodiments thus, cannot be practically performed by human beings as a mental process and is not directed to organizing any human activity.

As shown in FIG. 3, a controller-worker architecture is provided in which a controller 305 implements a fault tolerant linear solver 300 to generate solutions for algebraic linear systems in accordance with a pre-conditioned iterative solver mechanism of the illustrative embodiments. As further shown in FIG. 3, the fault tolerant linear solver 300 includes a straggler policy engine 310, a pre-conditioner 320, and a flexible iterative solver 330. The fault tolerant linear solver 300 operates in conjunction with controller matrix-vector multiplication (MVM) logic 340 of the controller 305 which operates to distribute workloads for MVM operations to the workers 350-380 and aggregate the results returned by the workers 350-380. The controller 305 and workers 350-380 may be in data communication with one another via one or more data networks 390 and corresponding data communication interfaces, Application Programming Interfaces (APIs), or the like (not shown).

When an algebraic linear system is to be solved, such as part of a larger operation, e.g., electrical network design operation, social networking operation, page rank operation, or the like, the elements of the algebraic linear system may be loaded into the controller 305, which may be a server computing system. That is, the elements of the algebraic linear system include a matrix A and the expected results vector b, with the algebraic linear system being solved for the vector x which when multiplied with the matrix X gives the expected results vector b, i.e., Ax=b. The MVM logic 340 operates to distribute rows of the matrix A as well as the vector b to each of the workers 350-380. That is, each worker 350-380 receives one or more of the rows from the matrix A, e.g., the i^{th} row of the matrix A is distributed to the i^{th} worker in the set of workers 350-380. Thus, each worker 350-380 performs its computations on the row of the matrix A allocated to it, based on the vector b. Each worker 350-380 generates a scalar result xᵢ that is returned to the controller 305. The controller 305 aggregates the results to generate the solution x, which may then be provided to other downstream applications and computing systems for performance of further operations based on the solution to the algebraic linear system.

In generating the solution to the algebraic linear system, after distributing the rows of the matrix A to the workers along with the vector b, the controller 305 waits to receive the results of the computations from the workers 350-380, i.e., the xᵢ scalar values. The controller 305 implements the fault tolerant linear solver 300 to control the generation of the solution, which includes implementation of the straggler policy engine 310. The straggler policy engine 310 monitors the return of results from the workers 350-380 to determine if any of the workers 350-380 become stragglers. This monitoring may be based on a predetermined allotted amount of time that each worker 350-380 is provided to complete their computations and return a result. If a worker 350-380 does not return a result within this predetermined allotted amount of time, the result is assumed to be 0 and the solving of the algebraic linear system is permitted to continue without further waiting for that worker to provide a computed result. Thus, once the predetermined allotted amount of time is reached, the resulting vector x comprises both actual calculation results from workers that were able to complete their computations within the predetermined allotted amount of time, and 0 values for workers that were stragglers. This results in a sparse vector for the matrix-vector multiplication in which only some of the results are able to be observed.

The fault tolerant linear solver 300 then generates a solution x for the algebraic linear system based on the operations of the pre-conditioner 320 and the flexible iterative solver 330. That is, the workers 350-380 generate inexact matrix-vector products. The solution x that is produced by the fault tolerant linear solver 300 is produced by the iterative procedure of the flexible iterative solver 330 of the illustrative embodiments.

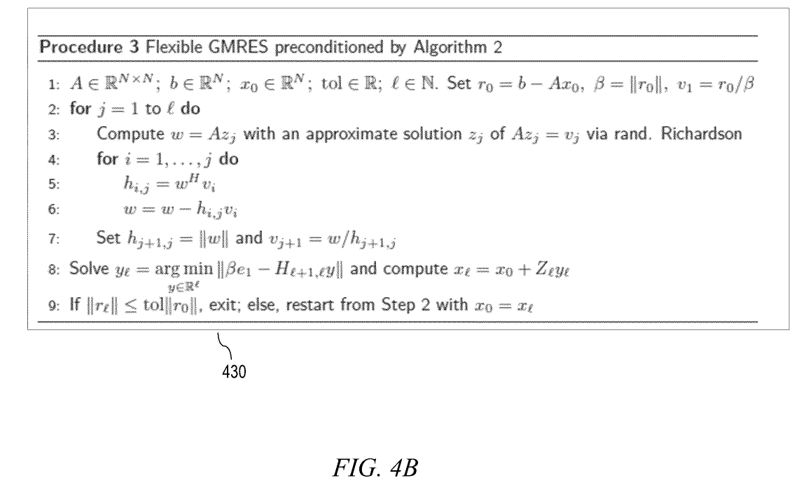

The pre-conditioner 320 implements a stationary iterative solver algorithm, such as algorithm 420 shown in FIG. 4A, to pre-condition the operation of the flexible iterative solver 330, which may implement a fault tolerant non-stationary linear solver algorithm, such as that shown in FIG. 4B, for example. A stationary iterative solver is named such because the solution x is expressed as finding the fixed point of a fixed iteration, whereas non-statutory solvers compute the solution via projection onto a subspace. The pre-conditioner 320 generates an approximation of the solution for the inner products of the non-stationary linear solver algorithm of the flexible iterative solver 330. The flexible iterative solver 330 then generates the actual solution for the algebraic linear system based on the approximations of the solution generated by the pre-conditioner 320.

Thus, the fault tolerant linear solver 300 is able to generate a solution for an algebraic linear system even when there are workers that are stragglers. The illustrative embodiments implement a policy that results associated with stragglers may be set to a predetermined value, e.g., 0, rather than waiting for the actual results from the stragglers, which would introduce additional delays and performance issues, or even restarting the computations. As a result, the process of computing the solution for the algebraic linear system is not subject to latency due to faults or slowdowns in the controller-worker architecture, whatever the possible cause of such faults or slowdowns, e.g., non-dedicated resources, actual failures, or the like. Hence, the mechanisms of the illustrative embodiments improve performance of any computing system or computer algorithms that rely on the solution of algebraic linear systems.

FIG. 4A is an example diagram of an algorithm for a pre-conditioner implementing a stationary linear solver in accordance with one illustrative embodiment. The example shown in FIG. 4A assumes that a randomized Richardson Iteration algorithm 420 is utilized for solving a linear system Az=v, similar to the Ax=b above, where z is a preconditioned vector that approximately satisfies “Az=v”, and v is given by the current iteration of the flexible iterative solver. With regard to the randomized Richardson Iteration algorithm 420 of the illustrative embodiments, let m denote the number of Richardson Iterations performed, where a Richardson Iterative method is shown as algorithm 410, and let T₁, . . . , Tₘ denote m instances of a random variable T with corresponding row subset samples T₁, . . . Tₘ⊆{1, 2, . . . , N} of the random row subset T such that Tᵢ=|Tᵢ|, i=1, . . . , m. The random variable T tells how many workers successfully computed their respective products. In other words, for an instance Tⱼ, there are N−Tⱼ stragglers, where N denotes the dimension of the problem.

In this case, the illustrative embodiments implements the randomized Richardson update scheme:

$$\hat{{z}_{ι}} = ( I - \hat{w} D = {D}_{{T}_{i}} A ) + wv \qquad ( 4 )$$

where w∈ [symbol] is the scalar parameter associated with a convergent classical Richardson iteration.

FIG. 4B is an example diagram of an algorithm for a fault tolerant non-stationary linear solver with a preconditioning based on a stationary linear solver in accordance with one illustrative embodiment. The algorithm 430 in FIG. 4B is an example of a Flexible GMRES algorithm that is preconditioned using the randomized Richardson Iteration algorithm 420 in FIG. 4A. The Flexible GMRES algorithm 430 allows the preconditioner to vary from one iteration to another. As shown in FIG. 4B, the preconditioner of the randomized Richardson Iteration algorithm 420 is introduced at line 3 where the value of w is computed and the randomized Richardson Iteration algorithm 420 is used to approximate the solution zⱼ of the matrix-vector product Azⱼ as vⱼ. The variable vⱼ is provided by the flexible iterative solver, e.g., the FGMRES, ad is the right-hand side of the linear system solved by the pre-conditioner.

In some cases, flexible GMRES allows variations in the preconditioner but may require exact matrix-vector products of w=Azⱼ. While this requirement may be relaxed as the flexible GMRES converges towards the solution of Ax=b, the flexible GMRES of the illustrative embodiments approximates w=Azⱼ via exploiting products of the form A×Tₖzⱼ, k=1, . . . , M. Let Ind(A×Tzj) return an N-length vector whose i^{th} entry is equal to 1 if i∈T and 0 otherwise. Accordingly, let dₖ=Ind(A×Tₖzⱼ) denote an N-length vector with N−Tₖ zero entries and Tₖ entries equal to 1, respectively. Setting the i^{th} entry of dₖ equal to 1 signals that the corresponding entry of the product w=Azⱼ is computed and available. As a result, the matrix-vector product w=Azⱼ can be computed via computing A×Tₖzⱼ, k=1, 2, . . . , M, and halting the procedure when d₁+ . . . +d_{M}≥1^{N}. Let T∈[1, N] be an integer. Then, for any M∈ [symbol] and series of products A×Tₖzⱼ, k=1, . . . , M, the probability of not observing an entry of the matrix-vector product w=Azⱼ is equal to

$${( \frac{N - T}{N} )}^{M} .$$

Let T be a random integer variable sampled uniformly from the interval [1, N]. Then, for any M∈ [symbol] and series of products A×Tₖzⱼ, k=1, . . . , M, the probability of not observing an entry of the matrix-vector product w=Azⱼ is equal to

$${( \frac{N - T}{2 N} )}^{M} .$$

In other words, put more simply, the chance of a certain worker is a straggler diminishes as M increases.

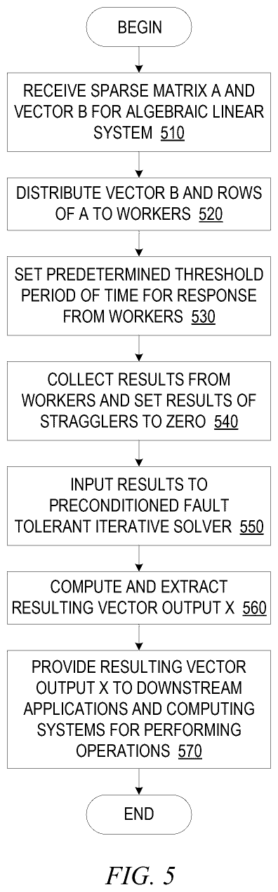

FIG. 5 is a flowchart outlining an example operation of a fault tolerant non-stationary linear solver in accordance with one illustrative embodiment. It should be appreciated that the operations outlined in FIG. 5 are specifically performed automatically by a computing tool of the illustrative embodiments and are not intended to be, and cannot practically be, performed by human beings either as mental processes or by organizing human activity. To the contrary, while human beings may, in some cases, initiate the performance of the operations set forth in FIG. 5, and may, in some cases, make use of the results generated as a consequence of the operations set forth in FIG. 5, the operations in FIG. 5 themselves are specifically performed by the computing tool in an automated manner.

As shown in FIG. 5, the operation starts with receiving a matrix A and a vector b of an algebraic linear system, where A and b are loaded into the server or controller for computation (step 510). The controller (server) distributes the rows of the matrix A to the workers such that each worker has at least one different row of the matrix A (step 520). The vector b is also distributed to each of the workers. The controller sets a predetermined allocated period of time for the workers to respond with results of the computations (step 530). The results from workers able to complete their computations within the predetermined allocated threshold period time are aggregated with 0 values for workers who are not able to complete their computations within the predetermined period of time, i.e., the stragglers (step 540). The results and 0 values are input to a preconditioned fault tolerant iterative solver, such as a Flexible GMRES with a preconditioner of a random Richardson Iteration (step 550). The resulting vector output x is computed and extracted (step 560). The resulting output x is provided to downstream computing systems and/or applications for further operations (step 570). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of fault-tolerant computing, comprising:
solving, by a controller computing device in a controller-worker computer architecture, a sparse algebraic linear system of equations with incomplete matrix-vector products, wherein the solving comprises:
computing, by a set of worker computing devices in the controller-worker computer architecture, matrix-vector products Ax=b, wherein A is a sparse matrix, x is a vector being multiplied, and b is a resultant vector;
determining, by the controller computing device, that a worker, of the set of worker computing devices, has not returned a result of its computation to the controller computing device within a threshold length of time; and
in response to determining that the worker has not returned the result within the threshold length of time, assuming, by the controller computing device, that the result is zero and continuing the computing of a solution to the sparse algebraic linear system of equations; and
providing, by the controller computing device, to a subsequent computing operation, the solution to the sparse algebraic linear system of equations as a basis for performing the subsequent computing operation.

2. The method of claim 1, wherein the solving uses a flexible iterative solver preconditioned by a Richardson Iteration preconditioner with inexact matrix-vector products.

3. The method of claim 2, wherein the flexible iterative solver is a flexible generalized minimal residual method algorithm, and wherein the Richardson Iteration preconditioner is a random Richardson Iteration algorithm comprising a random variable T representing a number of worker computing devices that successfully provide their corresponding matrix-vector product computation results to the controller computing device.

4. The method of claim 1, wherein computing the matrix-vector products comprises distributing, by the controller computing device to each worker computing device in the set of worker computing devices, the resultant vector b and a portion of the sparse matrix A.

5. The method of claim 4, wherein the portion of the sparse matrix A provided to a worker computing device in the set of worker computing devices is a corresponding row of the matrix A.

6. The method of claim 4, wherein computing the matrix-vector products further comprises computing, by each of one or more first worker computing devices in the set of worker computing devices, a corresponding matrix-vector product for the sparse algebraic linear system of equations, to thereby determine an element in x.

7. The method of claim 6, wherein the set of worker computing devices further comprise one or more second worker computing devices that do not return a corresponding result to the controller computing device within the threshold length of time, and wherein the elements in x corresponding to the one or more second worker computing devices are set to a value of 0.

8. The method of claim 7, wherein the one or more second worker computing devices are worker computing devices that have encountered a runtime fault or failure.

9. The method of claim 1, wherein the set of worker computing devices are part of a cloud computing system in which one or more of the worker computing devices in the set of worker computing devices are not dedicated only to computing matrix-vector products for solving the sparse algebraic linear system of equations and instead perform other operations in addition to computing matrix-vector products for solving the sparse algebraic linear system of equations.

10. The method of claim 1, wherein the subsequent computing operation is one of an electrical circuit design operation, a social networking application operation, or a web page search engine operation.

11. A computer program product comprising:
one or more computer-readable storage media; and
program instructions stored on the one or more computer-readable storage media to perform operations comprising:
solving, by a controller computing device in a controller-worker computer architecture, a sparse algebraic linear system of equations with incomplete matrix-vector products, wherein the solving comprises:
computing, by a set of worker computing devices in the controller-worker computer architecture, matrix-vector products Ax=b, wherein A is a sparse matrix, x is a vector being multiplied, and b is a resultant vector;
determining, by the controller computing device, that a worker, of the set of worker computing devices, has not returned a result of its computation to the controller computing device within a threshold length of time; and
in response to determining that the worker has not returned the result within the threshold length of time, assuming, by the controller computing device, that the result is zero and continuing the computing of a solution to the sparse algebraic linear system of equations; and
providing, by the controller computing device, to a subsequent computing operation, the solution to the sparse algebraic linear system of equations as a basis for performing the subsequent computing operation.

12. The computer program product of claim 11, wherein the solving uses a flexible iterative solver preconditioned by a Richardson Iteration preconditioner with inexact matrix-vector products.

13. The computer program product of claim 12, wherein the flexible iterative solver is a flexible generalized minimal residual method algorithm, and wherein the Richardson Iteration preconditioner is a random Richardson Iteration algorithm comprising a random variable T representing a number of worker computing devices that successfully provide their corresponding matrix-vector product computation results to the controller computing device.

14. The computer program product of claim 11, wherein computing the matrix-vector products comprises distributing, by the controller computing device to each worker computing device in the set of worker computing devices, the resultant vector b and a portion of the sparse matrix A.

15. The computer program product of claim 14, wherein the portion of the sparse matrix A provided to a worker computing device in the set of worker computing devices, is a corresponding row of the matrix A.

16. The computer program product of claim 14, wherein computing the matrix-vector products further comprises computing, by each of one or more first worker computing devices in the set of worker computing devices, a corresponding matrix-vector product for the sparse algebraic linear system of equations, to thereby determine an element in x.

17. The computer program product of claim 16, wherein the set of worker computing devices further comprise one or more second worker computing devices that do not return a corresponding result to the controller computing device within the threshold length of time, and wherein the elements in x corresponding to the one or more second worker computing devices are set to a value of 0.

18. The computer program product of claim 17, wherein the one or more second worker computing devices are worker computing devices that have encountered a runtime fault or failure.

19. The computer program product of claim 11, wherein the set of worker computing devices are part of a cloud computing system in which one or more of the worker computing devices in the set of worker computing devices are not dedicated only to computing matrix-vector products for solving the sparse algebraic linear system of equations and instead perform other operations in addition to computing matrix-vector products for solving the sparse algebraic linear system of equations.

20. A computer system comprising:
a processor set;
one or more computer-readable storage media; and
program instructions stored on the one or more computer-readable storage media to cause the processor set to perform operations comprising:
solving, by a controller computing device in a controller-worker computer architecture, a sparse algebraic linear system of equations with incomplete matrix-vector products, wherein the solving comprises:
computing, by a set of worker computing devices in the controller-worker computer architecture, matrix-vector products Ax=b, wherein A is a sparse matrix, x is a vector being multiplied, and b is a resultant vector;
determining, by the controller computing device, that a worker, of the set of worker computing devices, has not returned a result of its computation to the controller computing device within a threshold length of time; and
in response to determining that the worker has not returned the result within the threshold length of time, assuming, by the controller computing device, that the result is zero and continuing the computing of a solution to the sparse algebraic linear system of equations; and
providing, by the controller computing device, to a subsequent computing operation, the solution to the sparse algebraic linear system of equations as a basis for performing the subsequent computing operation.
